(19) United States
(12) Patent Application Publication
(10) Pub. No.: US 2013/0080306 A1
(43) Pub. Date: Mar. 28, 2013

(54) Apparatus and Method for Operating a Pool of Single Family Homes as a Master Limited Partnership

(71) Applicant: Robert B. Hellman, JR., Atherton, CA (US)

(72) Inventor: Robert B. Hellman, JR., Atherton, CA (US)

(73) Assignee: AMERICAN INFRASTRUCTURE MLP MANAGEMENT, LLC, Foster City, CA (US)

(21) Appl. No.: 13/243,901

(22) Filed: Sep. 23, 2011

(51) Int. Cl. G06Q 40/00

(52) U.S. Cl. 705/35

(57) ABSTRACT

A computer includes a processor and a memory. The memory stores capital data characterizing capital raised for the purchase of a pool of single family homes. Operating data characterizes rental fees collected from renting a sub-set of the single family homes and equity gains realized from selling another sub-set of the single family homes. A master limited partnership module with executable instructions executed by the processor designates master limited partnership income based upon the capital data, the operating data and terms of a pool master limited partnership for a pool of single family homes.

### CROSS REFERENCE TO RELATED APPLICATIONS

This application is related to U.S. Ser. No. 10/306,836, filed Nov. 27, 2002, entitled “Apparatus and Method for Operating a Death-Care Business as a Master Limited Partnership”, U.S. Ser. No. 11/558,371, filed Nov. 9, 2006, entitled “Apparatus and Method for Converting Investment Capital into Publicly Traded and Private Master Limited Partnerships”, U.S. Ser. No. 12/028,741, filed Feb. 8, 2008, entitled “Apparatus and Method for Operating a Landfill Business as a Master Limited Partnership”, U.S. Ser. No. 12/909,320, filed Oct. 21, 2010, entitled “Apparatus and Method for Operating Public Infrastructure as a Master Limited Partnership”, U.S. Ser. No. 13/168,905, filed Jun. 24, 2011, entitled “Apparatus and Method for Operating a Cold Storage Facility as a Master Limited Partnership” and U.S. Ser. No. 13/168,906, filed Jun. 24, 2011, entitled “Apparatus and Method for Operating a Water Source as a Master Limited Partnership.” The content of each application is incorporated herein by reference.

### BRIEF DESCRIPTION OF THE INVENTION

This invention relates generally to the funding of residential housing. More particularly, this invention relates to a computer implemented technique for operating a pool of single family homes as a master limited partnership.

### BACKGROUND OF THE INVENTION

A master limited partnership is a corporate organization governed by a contract between management (e.g., general partners) and investors (e.g., limited partners). A master limited partnership combines the tax benefits of a limited partnership with the liquidity of publicly traded securities. The master limited partnership was originally conceived as an organizational structure to capitalize on mature, low growth, cash generating businesses. Accordingly, master limited partnerships have been used in such industries as oil, gas, real estate, and natural resources.

Master limited partnerships typically carry dividend yields (e.g., 7-10%). As such, the securities generally trade on a yield basis. In the current market environment, such securities are in high demand due to their superior yield and the lower perceived risk of the stable underlying business.

In a master limited partnership, partners receive cash distributions rather than dividends. Unlike a corporation, qualifying, publicly traded master limited partnerships are not subject to federal and state income taxes. Instead, all income, gains, losses and deductions of a partnership are passed through to the partners who are required to report their allocable share on their individual tax returns.

Most master limited partnerships generate unrelated business taxable income that prevents most institutional investors from being able to invest in master limited partnerships. As a result, master limited partnerships are predominantly retail products sold to high net worth individuals and other tax paying entities.

The tax advantages of master limited partnerships were greatly reduced through the Tax Reform Act of 1987. In addition, the lines of business in which tax exempt master limited partnerships can operate were greatly limited through the same tax act.

According to the Internal Revenue Code, Section 7704(d), in order for a publicly traded partnership to avoid being taxed as a corporation, it must generate more than 90% of its gross income from qualifying sources, referred to as qualifying income. Master limited partnerships can have wholly-owned taxable subsidiaries to hold the assets that generate non-qualifying income. With this structure, an entity can generate less than 90% of its income from qualifying sources and still qualify as a master limited partnership by dropping the non-qualifying assets into the taxable subsidiary. The primary disadvantage with this structure is that the subsidiary is unable to shield its income from taxes and any dividends that are routed to the master limited partnership are subject to double taxation. The master limited partnership suffers a valuation discount for every dollar of taxes paid by the taxable subsidiary.

In view of the narrowing of the scope of qualifying industries through the Tax Reform Act of 1987 and the inefficiencies outlined above in restructuring businesses that have both qualifying and non-qualifying activities, the use of master limited partnerships outside of the natural resource sector has declined. In addition, despite the Tax Reform Act of 1987 preserving the qualification relating to the sale and/or rental of real property, there have only a couple instances of the MLP structure being utilized in a business conducting the sale or rental of real property, in each instance the business was limited to commercial real property. Most companies engaged in the ownership, sale and rental of real property have elected to organize under the Real Estate Investment Trust (REIT) structure.

The decline in the use of MLP structures has coincided with the decline in the United States of values in single family homes. Single family homes are structures designed for a single family on a piece of real estate zoned for a single family structure. In this context, single family homes are distinct from condominiums, apartments and duplexes

Many home owners have lost considerable amounts of equity in their homes. Many of these owners would like to refinance their mortgages, but are finding the prevailing financing market hostile. Many of these owners also have a desire to continue to live in their current homes, even if that entails a change in status from an owner to a renter.

Many homeowners are not in a position to adequately maintain their properties, consequently a growing number of single family homes are in a state of disrepair. There has been very little private investment in single family housing in view of long duration to positive cash flows and lack of access to government backed mortgages.

In view of the foregoing, it would be desirable to provide new funding mechanisms for single family homes. More particularly, it would be desirable to provide means (via a computer implemented technique) for a new source of financing of single family homes through a master limited partnership.

### SUMMARY OF THE INVENTION

The invention also includes a computer with a processor and a memory. The memory stores capital data characterizing capital raised for the purchase of single family homes. Operating data characterizes rental fees collected from renting a sub-set of the single family homes and equity gains realized from selling another sub-set of the single family homes. A master limited partnership module with executable instructions executed by the processor designates master limited partnership income based upon the capital data, the operating data and terms of a master limited partnership for a pool of single family homes.

### BRIEF DESCRIPTION OF THE FIGURES

The invention is more fully appreciated in connection with the following detailed description taken in conjunction with the accompanying drawings, in which:

FIG. 1 illustrates a computer configured to implement operations of the invention.

FIG. 2 illustrates processing operations associated with an embodiment of the invention.

Like reference numerals refer to corresponding parts throughout the several views of the drawings.

### DETAILED DESCRIPTION OF THE INVENTION

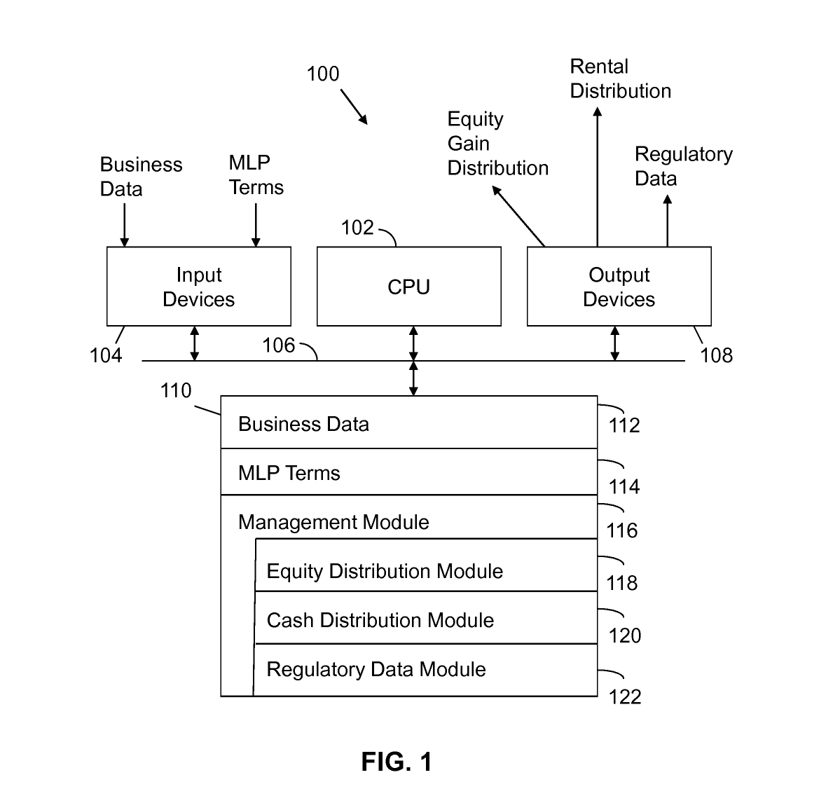

FIG. 1 illustrates a computer 100 configured to implement operations of the invention. The computer 100 includes a central processing unit 102 connected to a set of input devices 104 via a bus 106. The input devices 104 may include a keyboard, mouse, display and the like. The input devices 104 receive business data. The business data is information characterizing the operation of a commercial enterprise. Thus, the business data may include profit and loss statements, cash flow data, equity data, spreadsheets, and the like. The input devices 104 also receive master limited partnership (MLP) terms. In particular, the terms and conditions of a specified MLP are entered into the computer 100. For example, the terms may be expressed as a set of if-then-else executable instructions that characterize the rules and conditions associated with an MLP.

Output devices 108 are also connected to the bus 106. The output devices 108 may include a display, a printer, a network port, and the like. The output devices 108 are used to display or route information (e.g., data, wire transfer instructions, other payment instructions, and the like) computed in accordance with the invention. In one embodiment, this information includes equity gain distributions and rental income distributions.

A memory 110 is also connected to the bus 106. The memory 110 stores the business data 112 and the MLP terms 114. The memory also stores a management module 116. The management module includes executable instructions to implement operations associated with embodiments of the invention. For example, the management module 116 includes executable instructions to process the business data 112 and the MLP terms 114. An equity distribution module 118 associated with the management module 116 processes the business data 112 and the MLP terms 114 to calculate appropriate equity gain distributions to different investors. As discussed below, the equity gain distributions are based upon revenue from sales of assets in a pool of single family homes. As shown in FIG. 1, the output devices 108 may be used to facilitate an equity gain distribution (e.g., via a wire transfer or other payment instructions).

Similarly, the cash distribution module 120 includes executable instructions to calculate appropriate cash distributions to different investors. As discussed below, the cash distributions are based collected rental income from a pool of single family homes. Once again, the output devices 108 may be used to facilitate a cash distribution (e.g., via a wire transfer or other payment instructions).

The management module 116 may also include a regulatory data module 122 with executable instructions to generate regulatory data. By way of example, the regulatory data may be in the form of operating entity information, tax information, and the like.

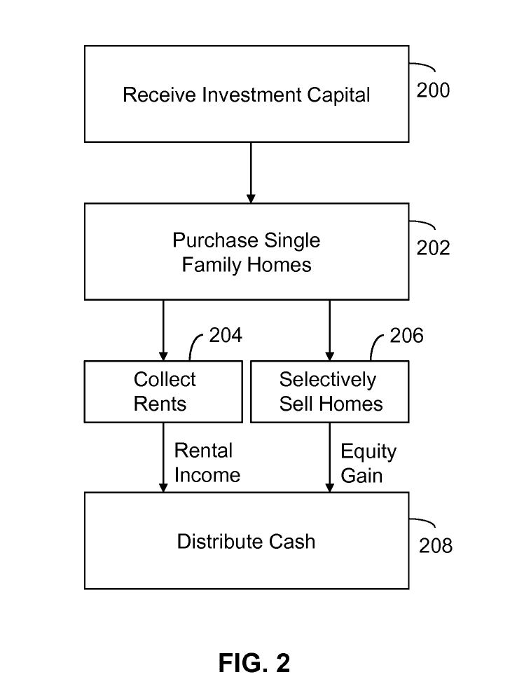

FIG. 2 illustrates processing operations associated with an embodiment of the invention. Initially, investment capital is received 200. The investment capital is used to purchase single family homes 202. Rents are subsequently collected 204. So, for example, a home may be purchased and the existing homeowner may be immediately converted to a renter. Alternately, a home may be purchased and the seller may vacate the premise with a new renter occupying the premise. This arrangement results in immediate qualifying income for the investors.

Over time, homes in the housing pool are selectively sold 206. This operation will typically be performed after several years, allowing for an increase in housing prices. Upon the sale of a home, an equity gain is realized. The rental income and equity gain income is then distributed 208. In particular, the income is distributed in accordance with the terms of a master limited partnership agreement for a pool of single family homes.

Those skilled in the art will recognize a number of advantages associated with the invention. First, the invention provides an attractive vehicle to encourage the utilization of private capital to purchase single family homes and thereby alleviate the current housing crisis with its abundance of unsold and foreclosed homes.

The MLP may be taken public through a public securities offering of limited partner units. This provides liquidity for investors. Further, a pool of housing assets may be assembled to generate stable and consistent cash flow, for example by purchasing single family homes in diverse geographies and/or at diverse price points. Thus, the invention facilitates access to competitively priced capital.

The disclosed techniques overcome problems associate with REIT structures. In particular, REIT structures are currently limited to 10 buy and/or sell transactions in a year. MLPs do not have a similar restriction. In addition, REIT structures cannot rely upon lease-to-own transactions, but MLPs do not have a similar restriction. Thus, the disclosed technique allows individual to enter into lease-to-own transactions and thereby provide an opportunity to improve personal balance sheets.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer, comprising:
a processor; and
a memory storing
capital data characterizing capital raised for the purchase of a pool of single family homes,
operating data characterizing rental fees collected from renting a sub-set of the single family homes and equity gains realized from selling another sub-set of the single family homes, and
a master limited partnership module with executable instructions executed by the processor to designate master limited partnership income based upon the capital data, the operating data and terms of a master limited partnership for a pool of single family homes.
